(19) United States
(12) Patent Application Publication
(10) Pub. No.: US 2025/0322537 A1
(43) Pub. Date: Oct. 16, 2025

(54) METHOD AND APPARATUS FOR FUSION OF DEPTH DATA FROM MULTIPLE SOURCES

(71) Applicant: FARO Technologies, Inc., Lake Mary, FL (US)

(72) Inventor: Jafar Amiri PARIAN, Schlieren (CH)

(21) Appl. No.: 19/233,530

(22) Filed: Jun. 10, 2025

Related U.S. Application Data
(63) Continuation of application No. PCT/US2023/084068, filed on Dec. 14, 2023.
(60) Provisional application No. 63/432,453, filed on Dec. 14, 2022.

(51) Int. Cl. G06T 7/55; G06T 7/521

(52) U.S. Cl. CPC G06T 7/55; G06T 7/521; G06T 2207/10028; G06T 2207/20221

(57) ABSTRACT

A method includes capturing images of an object in a three dimensional (3D) space and converting a first image into a first depth map having first pixels and converting a second image into a second depth map having second pixels, at least one of the second pixels overlapping at least one of the first pixels. The method further includes identifying from the first depth map a first pixel that overlaps a second pixel from the second depth map, the second pixel representing a correct position of the first pixel and the second pixel in the 3D space. The method further includes determining a correction vector for a position of the first pixel, determining adjusted positions of the first pixels using the correction vector, determining an adjusted first depth map with the adjusted positions of first pixels, and merging the second depth map with the adjusted first depth map.

### CROSS-REFERENCE TO RELATED APPLICATIONS

This application is a continuation of PCT Application Number PCT/US2023/084068, filed Dec. 14, 2023, the entire contents of which are incorporated by reference, and claims priority to U.S. Provisional Application No. 63/432,453, filed Dec. 14, 2022, and entitled “Fusion of depth data from different devices,” the entire contents of which are incorporated herein by reference.

### BACKGROUND

One or more embodiments described herein relates generally to fusing data from multiple sources, and more specifically, to the fusion of depth data from multiple sources.

The points in a three-dimensional (3D) point cloud, such as that generated by a 3D laser scanner time-of-flight (TOF) coordinate measurement device or created by algorithms that takes data from photogrammetry, are very useful. A 3D TOF laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. Laser scanners are used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

### BRIEF DESCRIPTION

According to one embodiment, a computer-implemented method is provided. The method includes capturing a plurality of images of an object in a three dimensional (3D) space with at least two imaging devices, the plurality of images including a first image of the object generated by a first imaging device and a second image of the object generated by a second imaging device having a different resolution than the first imaging device. The method further includes converting the first image into a first depth map having first pixels. The method further includes converting the second image into a second depth map having second pixels, at least one of the second pixels overlapping at least one of the first pixels. The method further includes identifying from the first depth map a first pixel that overlaps a second pixel from the second depth map. The method further includes selecting the second pixel as representing a correct position of the first pixel and the second pixel in the 3D space. The method further includes determining a correction vector for a position of the first pixel based on a distance from the second pixel. The method further includes determining adjusted positions of the first pixels using the correction vector. The method further includes determining an adjusted first depth map with the adjusted positions of first pixels, the second depth map comprising additional 3D positions for additional second pixels. The method further includes merging the second depth map with the adjusted first depth map. The method further includes displaying a point cloud representative of the object based on the merging.

According to another embodiment, a computer-implemented method is provided. The method includes capturing a plurality of images of an object in a three dimensional (3D) space with at least two imaging devices, the plurality of images including a first image of the object generated by a first imaging device and a second image of the object generated by a second imaging device having a different resolution than the first imaging device. The method further includes converting the first image into a first depth map having first pixels. The method further includes converting the second image into a second depth map having second pixels, wherein at least one of the second pixels overlaps at least one of the first pixels. The method further includes identifying from the first depth map a first pixel that overlaps a second pixel from the second depth map. The method further includes selecting the first pixel as representing a correct position of the first pixel and the second pixel in the 3D space. The method further includes determining a correction vector for a position of the second pixel based on a distance from the first pixel. The method further includes determining adjusted positions of the second pixels using the correction vector. The method further includes determining an adjusted second depth map with the adjusted positions of second pixels, the first depth map comprising additional 3D positions for additional second pixels. The method further includes merging the first depth map with the adjusted second depth map. The method further includes displaying a point cloud representative of the object based on the merging.

According to another embodiment, a system is provided that includes a memory having computer readable instructions and at least one processor for executing the computer readable instructions to perform operations. The operations include capturing a plurality of images of an object with at least two imaging devices, the plurality of images including a first image of the object generated by a first imaging device and a second image of the object generated by a second imaging device having a different resolution than the first imaging device. The operations further include performing dendogram calculations to generate a data set representing each of the plurality of images. The operations further include selecting the first image and the second image based on the dendogram. The operations further include converting the first image into a first depth map having first pixels. The operations further include converting the second image into a second depth map having second pixels, wherein the second pixels overlap the first pixels in three dimensional (3D) space. The operations further include selecting one of the first pixels and the second pixels as representing true positions of corresponding points in the 3D space. The operations further include determining correction vectors for unselected pixels in the 3D space based on distances from the selected pixels. The operations further include determining adjusted positions of the unselected pixels in the 3D space using the correction vectors. The operations further include determining an adjusted depth map with the adjusted positions of unselected pixels. The operations further include merging a depth map of the selected pixels with the adjusted depth map of the unselected pixels. The operations further include displaying a point cloud representative of the object based on the merging.

These and other advantages and features will become more apparent from the following description taken in conjunction with the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a perspective view of a laser scanner in accordance with an embodiment;

FIG. 2 is a side view of the laser scanner illustrating a method of measurement according to an embodiment;

FIG. 3 is a schematic illustration of the optical, mechanical, and electrical components of the laser scanner according to an embodiment;

FIG. 4 illustrates a schematic illustration of the laser scanner of FIG. 1 according to an embodiment;

FIG. 5 is a block diagram of an example computer system for use in conjunction with one or more embodiments;

FIG. 6 is a block diagram of a computer system for the fusion of depth data from multiple sources in a 2D space to be translated into a 3D point cloud according to one or more embodiments;

FIGS. 7A and 7B depict a flowchart of a computer-implemented method for the fusion of depth data from multiple sources according to one or more embodiments;

FIGS. 8A and 8B depict a visibility check according to one or more embodiments;

FIG. 9 depicts using a ray intersection angle for visibility check in a dendogram according to one or more embodiments;

FIG. 10A depicts a first signed distance value between two surfaces of depth maps according to one or more embodiments;

FIG. 10B depicts a second signed distance value between two surfaces of depth maps according to one or more embodiments;

FIG. 11 depicts graphs of different weight functions that have been normalized to [−1 and 1] according to one or more embodiments;

FIG. 12A depicts using a normal vector and a viewing vector in the dendogram to check for visibility according to one or more embodiments;

FIG. 12B depicts using a ratio of the first signed distance to the second signed distance in the dendogram to check for visibility based on being below a threshold according to one or more embodiments;

FIGS. 13A, 13B, 13C and 13D depict a fused point cloud from photogrammetry using different handheld cameras according to one or more embodiments.

FIG. 14 depicts a graphical presentation of a depth map or depth map image according to one or more embodiments; and

FIG. 15 depicts a dendogram as a visualization of image overlaps (i.e., overlapping regions) and/or visibility according to one or more embodiments; and

The detailed description explains embodiments of the disclosure, together with advantages and features, by way of example with reference to the drawings.

### DETAILED DESCRIPTION

Generating an image requires at least three values for each data point. These three values include the distance and two angles, or are transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer).

Many contemporary laser scanners include a camera mounted on the laser scanner for gathering camera digital images of the environment and for presenting the camera digital images to an operator of the laser scanner. By viewing the camera images, the operator of the scanner determines the field of view of the measured volume and adjust settings on the laser scanner to measure over a larger or smaller region of space. In addition, the camera digital images are transmitted to a processor to add color to the scanner image according to one or more embodiments. To generate a color scanner image, at least three positional coordinates (such as x, y, z) and three color values (such as red, green, blue “RGB”) are collected for each data point.

A 3D point cloud of data points is formed by the set of three positional coordinates (such as x, y, z) and three color values (such as red, green, blue “RGB”). Processing is generally performed on the 3D point cloud of data points which includes millions of data points. However, additional software processing tools for 3D data points in a 3D point cloud is helpful to a user.

Accordingly, while cameras and scanners and existing processing for 3D point clouds are suitable for their intended purposes, what is needed is a method for processing different pieces of data having certain features of embodiments disclosed herein.

The following are definitions and terminology.

Depth map, depth map image, 2D image of depth, and depth image denote a 2D array (a matrix) of depth values.

Passive technique is where a passive sensor receives naturally emitted electromagnetic (EM) energy within its field-of-view (FOV) and performs measurement using it.

Active technique is where an active sensor emits its own electromagnetic energy which is transmitted toward the object and receives energy reflected from the object. The received electromagnetic energy is used for measurement purposes.

Surface normal is a vector normal to the surface. The direction of this normal vector is typically towards the measurement device.

Viewing point, projection center, and standpoint denote a 3D physical point related to a device where all rays (light beams) pass through that point. In photogrammetry, it is called the projection center. In photography, it is called the viewing point.

External orientation, pose, and angles of viewpoint relate to the 6 transformation parameters including 3 angles (around 3 axes of the world coordinate system) and the translation along 3 axes of the world coordinate system, which orient the depth map in 3D space.

Signed distance denotes that a point on the surface of a given depth map has a distance to the surface computed from another depth map. This distance depending on the which surface is in front or behind has a positive or negative sign and is called signed distance. Typically, this distance is the signed shortest Euclidean distance.

One or more embodiments provide techniques for the fusion of depth data from multiple sources to create a 3D image of an object. A depth image is a 2D array or matrix in which each element of this matrix indicates the distance of that element to a 3D space. Capturing devices like laser scanners, 2D Light Detection and Ranging (LIDAR) sensors, mobile mapping devices, and photogrammetry devices produce depth data. Techniques like laser scanning and photogrammetry provide a regular grid of depth data stored in a 2D array. According to one or more embodiments, a novel method is provided that uses a 2D space for 3D spatial nearest neighbor searches, and the method is able to fuse depths obtained from different techniques and different capturing devices.

It is not practical to add up 3D points or the point clouds of different viewpoints. Because of overlaps in 3D points or the point clouds of different viewpoints, the final point cloud file is often very large without necessarily having valuable information. Using one or more embodiments described herein, the data of the overlapping regions are merged properly by the fusion of depth data, which improves the quality of the final point cloud. This is because the method uses weighted averaging that reduces noise and helps the overlapping regions to complement each other; therefore, the redundant data are combined so the fused data will be smaller in size but still contain even better content. According to one or more embodiments, example applications of the way the method of data fusion is utilized include any one or combination of the following: fusion of the depth data which are collected by the same technique like photogrammetry; fusion of the depth data which are collected by the same technique like LIDAR; fusion of the depth data which are collected by different techniques like photogrammetry, time-of flight laser scanners, phase-based laser scanners, and triangulation-based scanners (i.e., different capturing devices, such as a camera with LIDAR and a laser scanner); and fusion of the depth data taken at different times, for example, over 1 year of data collection is fused. Obtaining the geometry of 3D world objects is an ongoing topic with many practical applications, ranging from scanning small objects up to modeling complete cities for applications like a digital twin. 3D reconstruction techniques are classified into active and passive techniques. Active techniques rely on illuminating the scene, for example, by laser or structured light. Passive techniques rely on the existing illumination of the scene and then analyzing the multitude of images of the scene. Photogrammetry or multi-view stereo are well-known passive techniques.

Photogrammetry has many benefits compared to active techniques. Advantages of photogrammetry are that the capture process is simple and low cost, and it only requires standard imaging hardware like consumer digital cameras, which are available together with many smart phones. In addition, photogrammetry provides color information of the scene with no extra cost.

Point clouds generated by photogrammetry are often much noisier and contain more outliers than those obtained using active techniques like laser scanning. This noise is due to uncertainties at camera calibration, uncertainties of image alignment, and ambiguities at pixel matching. It should be noted that among active sensors, like mobile mapping, also generate high noise compared to stationary or static laser scanning. Therefore, some active sensors pose greater challenges to 3D reconstruction and especially further step analysis like meshing and realistic texture mapping.

Consumer scanners (e.g., passive: photogrammetry, and active: 2D Lidar like IPHONE Lidar) have evolved recently and add valuable information to professional scanners (e.g., passive: professional photogrammetry, active: static or mobile mapping scanners like FARO FOCUS Laser Scanners or GEOSLAM scanners). Therefore, the creation of a digital twin is not limited to one technique. For efficiency, cost-saving, and quality reasons, both consumer and professional passive and active sensors are contributing to the 3D reconstruction of the real world. Each technique produces a depth map from its standpoint or viewing point. Once these depth maps are combined elegantly, they complement each other, and negate existing noise and remove outliers, according to one or more embodiments. According to one or more embodiments, the outcome of this combination, which is called “fusion” in this document, generates one of the best 3D presentations of the real world for digital display.

Technical effects and solutions of one or more embodiments include the efficient and automatic use of a novel method (which includes one or more algorithms) for processing the fusion of depth map data from different techniques (e.g., passive and active techniques) by taking into consideration the noise, outliers, uncertainty of reconstruction, etc. This results in the creation of a single description of the surface for a 3D image by fusing (merging) multiple depth/range images, which are generated using different sources (i.e., different devices) and different techniques (i.e., different active techniques and/or different passive techniques). As further technical effects and solutions, this novel method of depth map fusion has a low computational complexity and a low memory footprint for the execution. Particularly, it is computed in a 2D space and does not require a 3D data structure when merging the data of the depth map. The method is less sensitive to noise and blunders, especially when using noisy depth maps, because the method avoids performing a normal vector computation. The method is a multi-resolution approach and maintains the density of the measured points at original resolution of the depth map image per device.

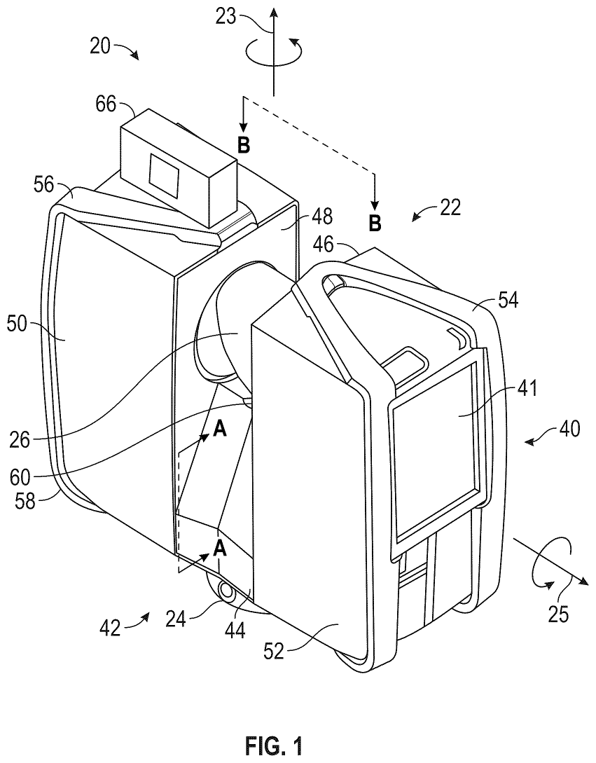

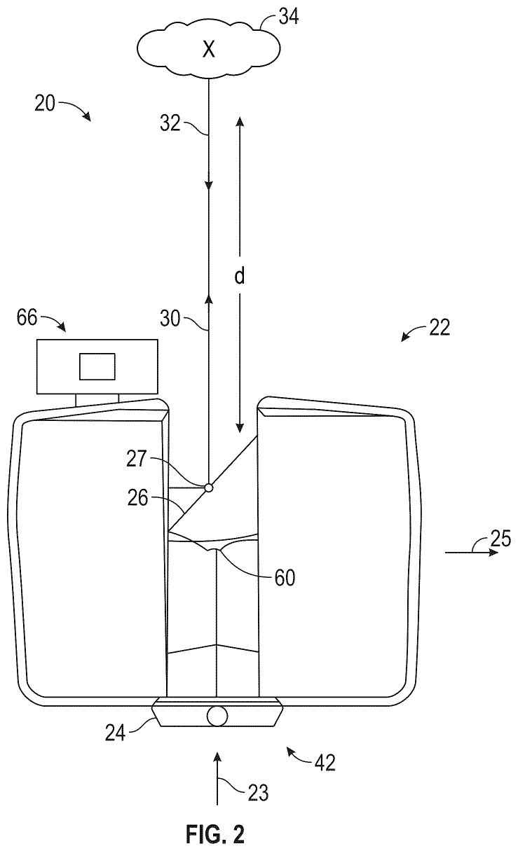

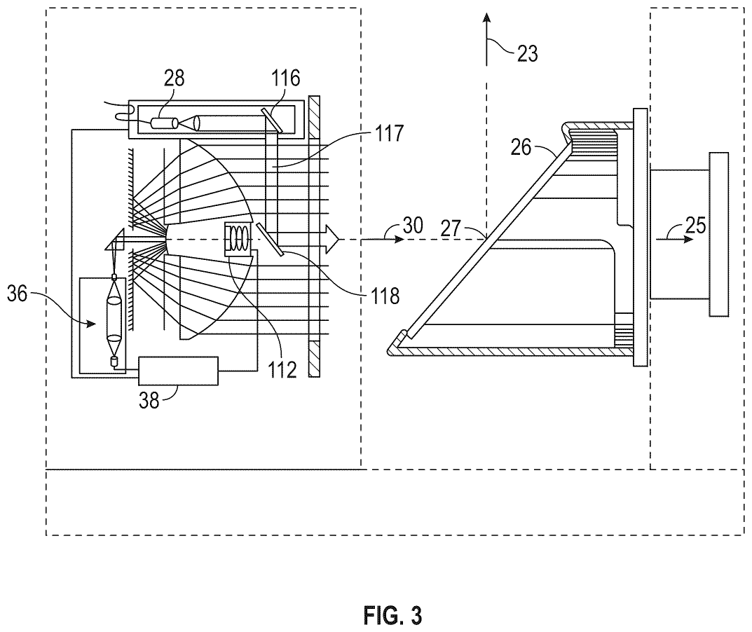

FIGS. 1, 2, and 3 depict a coordinate measurement device, such as a laser scanner 20 for optically scanning and measuring the environment surrounding the laser scanner 20. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which is rotated about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms “azimuth axis” and “zenith axis” are substituted for the terms “vertical axis” and “horizontal axis,” respectively. The term “pan axis” or “standing axis” is also used as an alternative to “vertical axis.”

The measuring head 22 is further provided with an electromagnetic radiation emitter, such as light emitter 28, for example, that emits an emitted light beam 30. In one embodiment, the emitted light beam 30 is a coherent light beam such as a laser beam. According to one or more embodiments, the laser beam has a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths are used in various embodiments. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 also collects gray-scale information related to the received optical power (equivalent to the term “brightness.”) The gray-scale value is determined at least in part, for example, by integration of the bandpass-filtered and amplified signal in the light receiver 36 over a measuring period attributed to the object point X.

The measuring head 22 includes a display device 40 integrated into the laser scanner 20. The display device 40 includes a graphical touch screen 41, as shown in FIG. 1, which allows the operator to set the parameters or initiate the operation of the laser scanner 20. For example, the screen 41 has a user interface that allows the operator to provide measurement instructions to the device, and the screen also displays measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 are coupled to the traverse 42, the walls 46, 48 and the shells 50, 52 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 52, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depend on signal strength, which are measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 is a device that captures and measures a parameter associated with the scanned area or the scanned object and provides a signal representing the measured quantities over an image acquisition area. The auxiliary image acquisition device 66 is one or more of (but is not limited thereto) a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 is a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

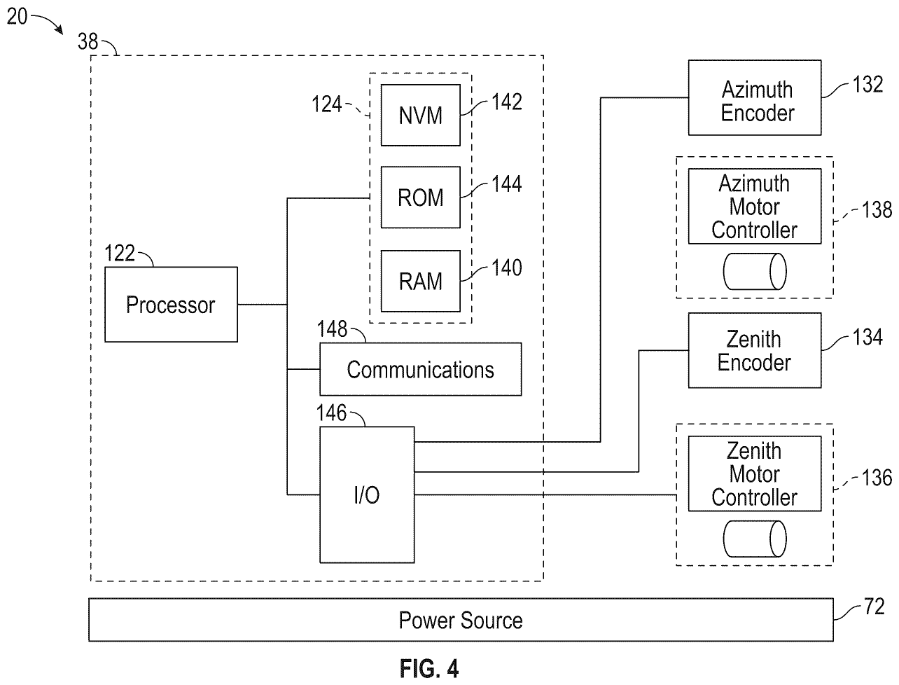

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors are microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera and is given certain instructions for the purpose of generating a 3D point cloud of a scanned environment. Controller 38 provides operating signals to the light source 28, light receiver 36, panoramic camera, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 is one or more of one or more LEDs (light-emitting diodes), an LCD (liquid-crystal diode) display, a CRT (cathode ray tube) display, a touchscreen display or the like. A keypad is also be coupled to the user interface for providing data input to controller 38. In one embodiment, the user interface is arranged or executed on a mobile computing device that is coupled for communication, such as via a wired or wireless communications medium (e.g., Ethernet, serial, USB, BLUETOOTH or WiFi) for example, to the laser scanner 20.

The controller 38 is also coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet Protocol), RS-232, ModBus, and the like. Additional systems are also connected to LAN with the controllers 38 in each of these systems being configured to send and receive data to and from remote computers and other systems. The LAN is connected to the Internet. This connection allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software is encodable in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud is generated or created using other types of scanners, such as but not limited to triangulation scanners, area scanners, structured-light scanners, laser line scanners, flying dot scanners, and photogrammetry devices for example.

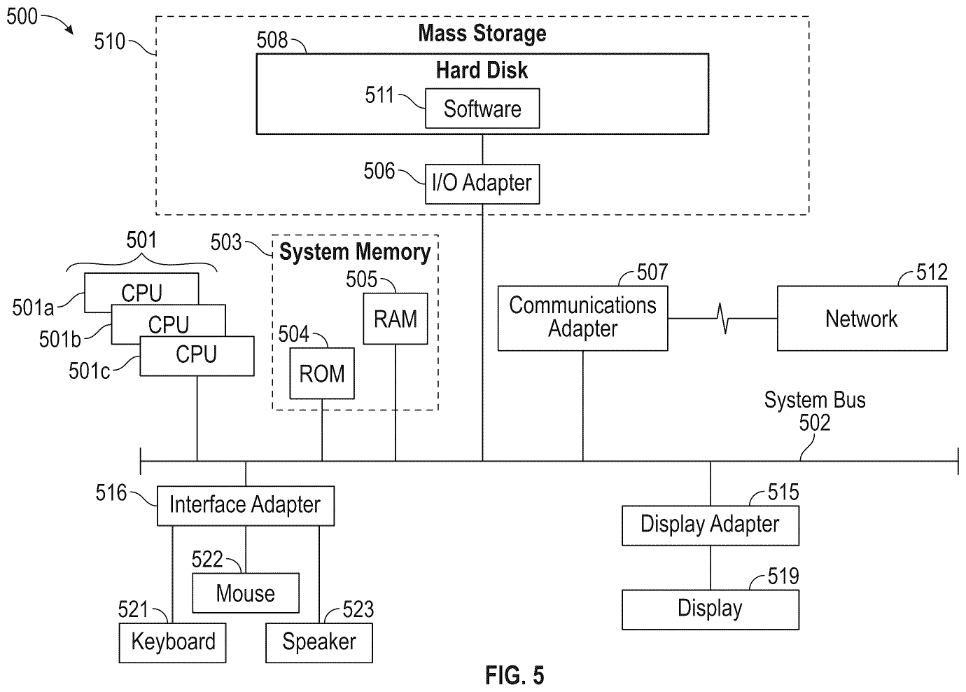

Turning now to FIG. 5, a computer system 500 is generally shown in accordance with one or more embodiments. The computer system 500 is an electronic, computer framework comprising and/or employing any number and combination of computing devices and networks utilizing various communication technologies, as described herein. The computer system 500 is easily scalable, extensible, and modular, with the ability to change to different services or reconfigure some features independently of others. The computer system 500 is, for example, a server, desktop computer, laptop computer, tablet computer, or smartphone. In some examples, computer system 500 is a cloud computing node. Computer system 500 is described in the general context of computer system executable instructions, such as program modules, being executed by a computer system. Generally, program modules include routines, programs, objects, components, logic, data structures, and so on that perform particular tasks or implement particular abstract data types. Computer system 500 is practiced in distributed cloud computing environments where tasks are performed by remote processing devices that are linked through a communications network. In a distributed cloud computing environment, program modules are located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 are a single-core processor, multi-core processor, computing cluster, or any number of other configurations. The processors 501, also referred to as processing circuits, are coupled via a system bus 502 to a system memory 503 and various other components. The system memory 503 includes a read only memory (ROM) 504 and a random access memory (RAM) 505. The ROM 504 is coupled to the system bus 502 and includes a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 includes random access memory (RAM), read only memory, flash memory, or any other suitable memory systems.

The computer system 500 comprises an input/output (I/O) adapter 506 and a communications adapter 507 coupled to the system bus 502. The I/O adapter 506 is a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 is stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which is an outside network, enabling the computer system 500 to communicate with other such systems. In one embodiment, a portion of the system memory 503 and the mass storage 510 collectively store an operating system, which is any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 are connected to one or more I/O buses that are connected to the system bus 502 via an intermediate bus bridge (not shown). A display 519 (e.g., a screen or a display monitor) is connected to the system bus 502 by the display adapter 515, which includes a graphics controller to improve the performance of graphics intensive applications and a video controller. A keyboard 521, a mouse 522, a speaker 523, etc., are interconnected to the system bus 502 via the interface adapter 516, which includes, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input means such as the keyboard 521 and the mouse 522, and output capability including the speaker 523 and the display 519.

In some embodiments, the communications adapter 507 transmits data using any suitable interface or protocol, such as the internet small computer system interface, among others. The network 512 is a cellular network, a radio network, a wide area network (WAN), a local area network (LAN), or the Internet, among others. An external computing device connects to the computer system 500 through the network 512. In some examples, an external computing device is an external webserver or a cloud computing node.

It is to be understood that the block diagram of FIG. 5 is not intended to indicate that the computer system 500 is to include all of the components shown in FIG. 5. Rather, the computer system 500 includes any appropriate fewer or additional components not illustrated in FIG. 5 (e.g., additional memory components, embedded controllers, modules, additional network interfaces, etc.). Further, the embodiments described herein with respect to computer system 500 are implemented with any appropriate logic, wherein the logic, as referred to herein, includes any suitable hardware (e.g., a processor, an embedded controller, or an application specific integrated circuit, among others), software (e.g., an application, among others), firmware, or any suitable combination of hardware, software, and firmware, in various embodiments.

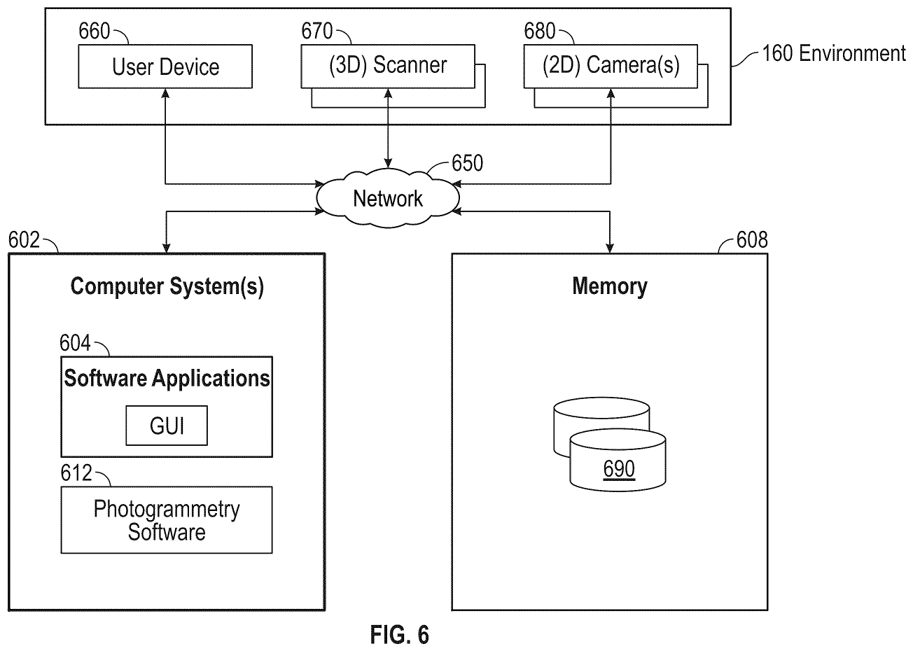

FIG. 6 is a block diagram of a computer system 602 for the fusion of depth data from multiple sources (e.g., multiple capturing devices) which utilize multiple techniques according to one or more embodiments. Elements of computer system 500 are used in and/or integrated in computer system 602.

Data in database 690 in memory 608 includes a 3D point cloud, also referred to as 3D point cloud data, point cloud, a 3D image, etc. The 3D point cloud includes 3D point cloud data points. Data in database 690 in memory 608 includes 2D data of 2D images along with their respective depth data. For example, the 2D data includes RGB data points each having its own distance data, range data, or depth data.

In an embodiment, the 2D images are acquired while performing photogrammetry. The data in database 690 is generated by a camera via photogrammetry. Other types of coordinate measurement devices are used for generating the 3D point cloud data, such as but not limited to a TOF laser scanner, a structured light scanner or a triangulation scanner, and/or another suitable three-dimensional coordinate scanning device. Example scanner(s) 670, such as a TOF laser scanner for example, is utilized to capture 3D data in an environment 160. Examples camera(s) 680 are utilized to capture 2D data including depth data.

In one or more embodiments, software application 604 is employed by a user for processing and manipulating 2D images and 3D point cloud data using a user interface such as, for example, a keyboard, mouse, touch screen, stylus, etc. Software application 604 includes and/or work with a graphical user interface (GUI), and features of the software application 604 including algorithms receive and use 2D data and 3D data as discussed herein. As understood by one of ordinary skill in the art, software application 604 includes functionality for processing any 2D image and 3D image including a 3D point cloud. In one or more embodiments, the software application 604 includes features of, be representative of, and/or be implemented in FARO ZONE 2D software, FARO ZONE 3D software, FARO PHOTOCORE software, and/or FARO SCENE software, all of which are provided by FARO Technologies, Inc. Software application 604 calls and/or includes the features and functionality of photogrammetry software 612. Photogrammetry is a technique to obtain reliable data of real-world objects in the environment by creating 3D models from photos. 2D and 3D data are extracted from an image, and with overlapping photos of an object, building, scene, or terrain, converted into a digital 3D model.

Photogrammetry is a technique for modeling objects using images, such as photographic images acquired by a digital camera for example. Photogrammetry makes 3D models from 2D images or photographs. When two or more images are acquired at different positions that have an overlapping field of view, common points or features are identified on each image. By projecting a ray from the camera location to the feature/point on the object, the 3D coordinate of the feature/point is determined using, for example, trigonometry or triangulation. In some examples, photogrammetry is based on markers/targets (e.g., lights or reflective stickers) or based on natural features. To perform photogrammetry, for example, images are captured, such as with a camera (e.g., the camera 680) having a sensor, such as a photosensitive array for example. By acquiring multiple images of an object, or a portion of the object, from different positions or orientations, 3D coordinates of points on the object are determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,659,753, the contents of which are incorporated by reference herein. With photogrammetry, two or more images are captured and used to determine 3D coordinates of features.

The various components, modules, engines, etc. described regarding the computer system 602 are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein are a combination of hardware and programming. The programming is processor executable instructions stored on a tangible memory, and the hardware includes the computer system 602 for executing those instructions. Thus, a system memory (e.g., the memory 608) stores program instructions that when executed by the computer system 602 implements the engines described herein. Other engines are also utilized to include other features and functionality described in other examples herein.

A network adapter (not shown) provides for the computer system 602 to transmit data to and/or receive data from other sources, such as other processing systems, data repositories, and the like. As an example, the computer system 602 transmits data to and/or receives data from the camera 680, the scanner 670, and/or a user device 660 directly and/or via a network 650.

The network 650 represents any one or a combination of different types of suitable communications networks such as, for example, cable networks, public networks (e.g., the Internet), private networks, wireless networks, cellular networks, or any other suitable private and/or public networks. Further, the network 650 has any suitable communication range associated therewith and includes, for example, global networks (e.g., the Internet), metropolitan area networks (MANs), wide area networks (WANs), local area networks (LANs), or personal area networks (PANs). In addition, the network 650 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 is a 2D camera or a 3D camera (RGBD or time-of-flight for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 includes components such as a processing device, a memory, a network adapter, and the like, which is functionally similar to those included in the computer system 500, 602 as described herein.

In some examples, the camera 680 is mounted to a mobile base, which is moved about the environment 160. In some examples, the camera 680 is disposed in or mounted to an unmanned aerial vehicle. In various examples, the camera 680 is mounted on a manned aerial vehicle and/or unmanned aerial vehicle, generally referred to as a drone. In some examples, the camera 680 is mounted to a fixture, which is user-configurable to rotate about a roll axis, a pan axis, and a tilt axis. In such examples, the camera 680 is mounted to the fixture to rotate about the roll axis, the pan axis, and the tilt axis. Other configurations of mounting options for the camera 680 also are possible.

A coordinate measurement device, such as the scanner 670 for example, is any suitable device for measuring 3D coordinates or points in an environment, such as the environment 160, to generate data about the environment. The scanner 670 is implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein refer to a laser scanner, this is for example purposes and the claims should not be so limited. In other embodiments, other types of coordinate measurement devices or combinations of coordinate measurement devices are used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They are used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which is transmitted to the computer system 602 and stored in the database 690 about the environment 160.

In some examples, the scanner 670 is mounted to a mobile base, which is moved about the environment 160. In some examples, the scanner 670 is disposed in or mounted to an unmanned aerial vehicle. In various examples, the scanner 670 is mounted on a manned aerial vehicle and/or unmanned aerial vehicle, generally referred to as a drone. In some examples, the scanner 670 is mounted to a fixture, which is user-configurable to rotate about a roll axis, a pan axis, and a tilt axis. In such examples, the scanner 670 is mounted to the fixture to rotate about the roll axis, the pan axis, and the tilt axis. Other configurations of mounting options for the scanner 670 also are possible.

According to one or more embodiments described herein, the camera 680 captures 2D image(s) of the environment 160 and the scanner 670 captures 3D information of the environment 160. In some examples, the camera 680 and the scanner 670 are separate devices; however, in some examples, the camera 680 and the scanner 670 are integrated into a single device. For example, the camera 680 includes depth acquisition functionality and/or is used in combination with a 3D acquisition depth camera, such as a time of flight camera, a stereo camera, a triangulation scanner, LIDAR, and the like. In some examples, 3D information is measured/acquired/captured using a projected light pattern and a second camera (or the camera 680) using triangulation techniques for performing depth determinations. In some examples, a time-of-flight (TOF) approach is used to enable intensity information (2D) and depth information (3D) to be acquired/captured. The camera 680 is a stereo-camera to facilitate 3D acquisition according to an embodiment. In some examples, a 2D image and 3D information (i.e., a 3D data set) is captured/acquired at the same time; however, the 2D image and the 3D information may be obtained at different times.

The user device 660 (e.g., a smartphone, a laptop or desktop computer, a tablet computer, a wearable computing device, a smart display, and the like) is also located within or proximate to the environment 160 according to one or more embodiments. The user device 660 displays an image of the environment 160, such as on a display of the user device 660 (e.g., the display 519 of the computer system 500 of FIG. 5) along with a digital visual element. In some examples, the user device 660 includes components such as a processor, a memory, an input device (e.g., a touchscreen, a mouse, a microphone, etc.), an output device (e.g., a display, a speaker, etc.), and the like.

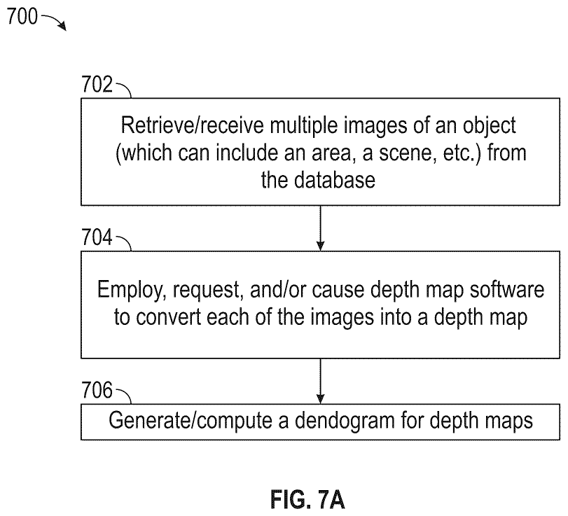

FIGS. 7A and 7B are a flowchart of a computer-implemented method 700 for the fusion of depth data of overlapping regions in a 2D space from multiple sources to generate a 3D point cloud according to one or more embodiments. The computer-implemented method 700 is performed by or implemented on any suitable processing system, for example, the computer system 602 in FIG. 6, a cloud computing node, and/or combinations thereof.

At block 702, the software applications 604 are configured to retrieve multiple images of an object (which include an area, a scene, etc.) from the database 690. The multiple images of an object (which include an area, a scene, etc.) are captured by a single device and/or by multiple devices according to one or more embodiments. Numerous images (e.g., typically several hundred images, thousands, etc.) are captured and stored as data in database 690 in computer system 602. Example capturing devices include one or more scanners 670, one or more cameras 680, etc. Any device discussed herein can be utilized to capture the images such that each data point includes a depth value (also referred to as a distance value). Each of the data points of the images include RGB data along with a depth value according to one or more embodiments.

At block 704, the software applications 604 are configured to employ, request, and/or cause depth map software to convert each of the images into a depth map. Depth map software, also called depth map generators, is known by one of ordinary skill in the art and is utilized accordingly. Depth maps refer to a 2D image where there is a depth value assigned to each pixel of the image. This is also sometimes referred to as a 2½ D image. In one or more embodiments, the depth map for each image is prestored in the database 690, and the software applications 604 retrieve the depth maps for the images. As noted herein, the depth map refers to a 2D array (a matrix) of depth values for an image, where each pixel (or data point) in the image has its own depth value.

At block 706, the software applications 604 are configured to generate/compute a dendogram for overlapping depth maps. Depth maps that overlap (i.e., have overlapping regions of their images) are determined using any technique that is known to one of ordinary skill in the art. In one more embodiments, each image on which a depth map is based is labelled, for example, as the front, left side, right side, and/or back. The depth maps of images with the same label and/or adjacent labels (e.g., the left side is adjacent to the back of an object as well as the front of the object) are utilized in the same dendogram, and therefore considered to be overlapping depth maps and/or correspond to images that have overlapping regions resulting in overlapping depth maps. Any technique for determining overlapping depth maps are utilized, and one or more embodiments are not meant to be limited to any single technique. Although examples refer to a single dendogram for ease of understanding, it should be appreciated that the description is applied by analogy to more than one dendogram in one or more embodiments.

At block 707, the software applications 604 are configured to, for each depth map, by using its dendogram, find the next overlapping depth map. At blocks 708 and 709, the software applications 604 are configured to determine/check, for every two depth maps, whether a 3D point that has been back projected into a first depth map (or depth map image) is visible in the second depth map, based on a visibility vector and/or a normal vector, and the software applications 604 further determine if the 3D point corresponding to the first depth map is visible in the second depth map. The software applications 604 go over all 3D points of the first depth map. For a given 3D point in the first depth map, the software applications 604 back projects it to the second depth map (as well as other depth maps), using any well-known technique understood by one of ordinary skill in the art. The 3D points are estimated using depth values and exterior orientation of images. In other words, each pixel of the depth map is transformed into 3D coordinates. Moreover, by knowing the exterior orientations, the software applications 604 back project the 3D points.

At block 710, if a 3D point from the first depth map is visible in the second depth map (second depth map is picked from the list of overlapping images which have been already computed through dendogram computation), the software applications 604 are configured to keep the corresponding second pixel/point (that corresponds to the back projection of the 3D point) in the second depth map.

At block 712, if a 3D point from the first depth map is not visible in the second depth map, the software applications 604 are configured to eliminate the use of (the second pixel/point in) the second depth map for that particular 3D point and move to comparisons for the next depth map (if there is another depth map) and/or move to analysis for another 3D point in the overlapping regions of the first and second depth maps. Blocks 708, 709, 710, and 712 are repeated for all the overlapping depth maps and their overlapping regions. The pixels/points are kept/stored for depth maps where the pixels/points have visibility to the respective 3D points in 2D space. In other words, the depth maps remaining are overlapping depth maps.

At block 714, the software applications 604 are configured to perform depth map refinement for a given depth map by determining a correction vector for each 3D pixel in the depth map and moving the 3D pixel with an amount equal to the 3D correction vector, and by applying a weight to each corrected 3D pixel. The weight takes into account a distance that the device is from the object, where the device captured the image from which the depth map was made. For example, there are two pixels/points representing a single 3D point, for example, a first pixel/point from the first depth map and a second pixel from the second depth map. Refinement of the two depth maps is performed by determining and moving the first pixel/point a distance according to a first correction vector and moving the second pixel/point a distance according to a second correction vector. Eventually the first pixel/point or the second pixel/point is to be selected as representative of the 3D point, as discussed below during the depth maps merger.

For better accuracy, block 715 is optionally iterated nominally 3-5 times and the value of depth maps are updated after each complete round of refinement.

At block 716, the software applications 604 are configured to create a merged/fused data point cloud by translating all the merged pixels (or 2D points) from a 2D space in the depth maps back to a 3D space, such that the 3D points generated from the overlapping regions are utilized with other 3D points that were not in the overlapping regions. This results in a single discrete 3D point cloud, which is saved in database 690 and/or output for display.

For example, one of the two pixels/points is selected to be the 3D point. In one example case, the first pixel/point is selected as representative of the 3D point based, at least in part, on the first pixel/point being captured by a capturing device that was closer to the surface of the object than the device for the second pixel/point. Additionally, and/or alternatively, the first pixel/point is selected as representative of the 3D point based, at least in part, on the first pixel/point being captured by a capturing device having less uncertainty (or higher resolution) than the device used for capturing the second pixel/point, where the uncertainty is added in the weights.

For ease of understanding and not limitation, section headings and subheadings are utilized below. It should be appreciated that embodiments are not meant to be limited by the headings. The software applications 604 execute and/or cause execution of algorithms discussed according to one or more embodiments. The software applications 604 include computer-executable instructions for performing algorithms for dendogram computation, depth map refinement, and depth map fusion, which compute data in the overlapping regions in 2D space, selects the best pixels/points from the overlapping regions, and fuses the selected points in 3D space, resulting in a fused (3D) point cloud.

In the state-of-the-art, most methods use a voxel based volumetric representation to cache the implicit function in 3D space. However, algorithms of the software applications 604 works directly in 2D image space. Accordingly, embodiments therefore work with lower memory requirements and avoid 3D search and operations, which are more computationally expensive (i.e., require more computer processing resources) compared to 2D search and operations. The dendogram computation discussed herein is also faster when compared to volumetric approaches.

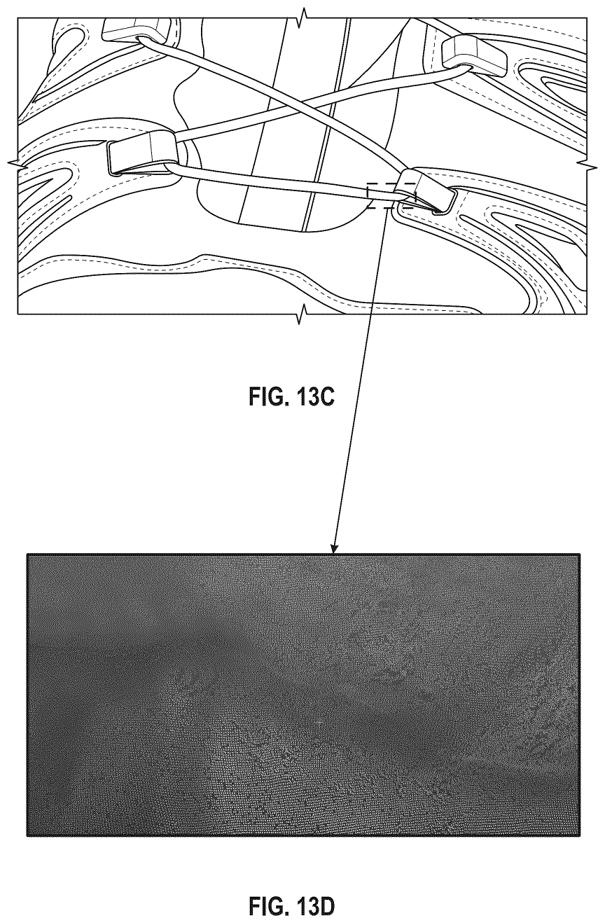

As an example, FIG. 14 is a graphical presentation of a depth map (i.e., image). The “A” denotes the image plane seen from the side. The “B” illustrates the optical axis (of the device capturing the image), and the “C” identifies the projection center.

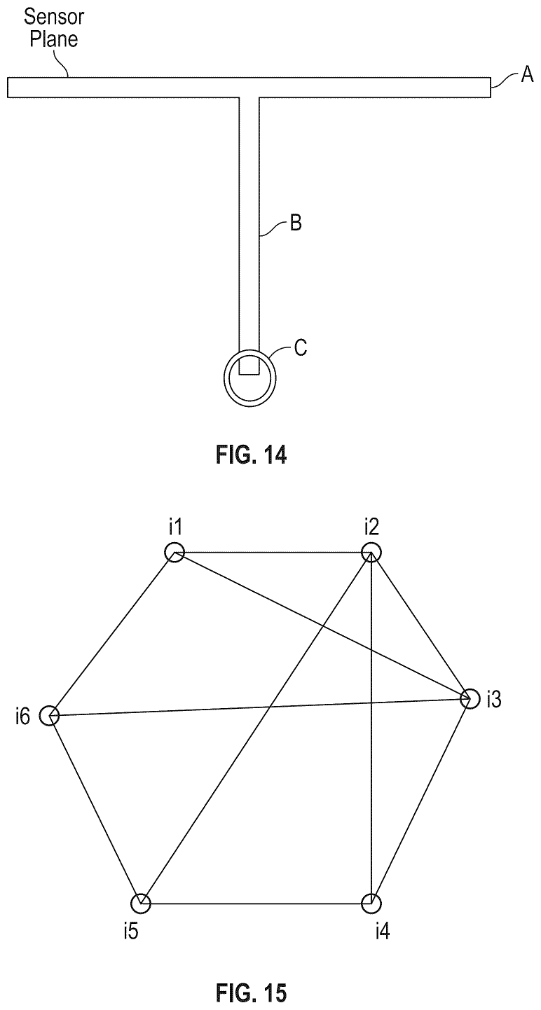

FIG. 15 illustrates a dendogram as a visualization of the image overlaps (i.e., overlapping regions) and/or visibility. In FIG. 15, there are 6 images (i1, i2, . . . , i6) represented as examples. The lines between images indicate that the images have overlap or that a portion of a surface (of the captured object) is visible among them. For example, i1 has an overlap with {i6, i2, i3}. The following summarizes this dendogram: i1: {i6, i2, i3}, i2: {i1, i3, i4, i5}, i3: {i1, i2, i4, i6}, i4: {i2, i3, i5}, i5: {i2, i4, i6}, and i6: {i5, i1,i3}

### 1. Dendogram Computation

A dendogram is a topological structure of overlapping depth maps. The dendogram is created to answer the query of what depth image is potentially seen by other depth maps.

It is not practical to assume that each depth map is seen by all other depth maps, because the depth refinement and fusion in the next processes becomes very time consuming. In addition, if the dendogram is very inaccurate, the resulting surface from depth fusion still has noise and the surface is not as discrete as expected. Therefore, a relatively accurate dendogram is beneficial. It should approximately demonstrate a correct topology of the overlapping images.

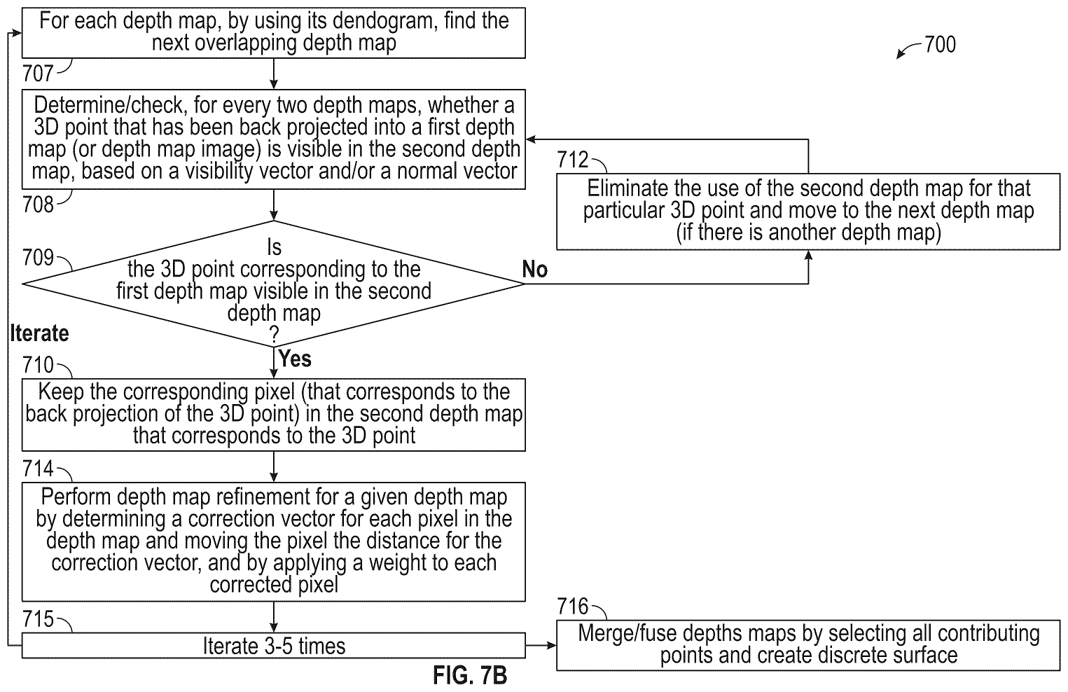

FIG. 8A illustrates that a dendogram is computed by back projecting 3D points (such as example 3D point P) of a depth map image (i₁) into other depth map images (for example, i₂, i₃, i₄). It should be appreciated that the start point is any point. As a depth map is a matrix of pixels, and the object is to check all these pixels, the process starts row by row and checks each pixel. If the back projected point (p₃, p₄) is seen by another depth map image, then the visibility is checked by computing the angle of the normal vector (\vec{n}) and the back projection ray illustrated as a dotted line in FIG. 8A. If the angle is less than 90°, the 3D point P is considered visible in another image and that image is an overlapping image. This process is repeated for all 3D points and the list of overlapping images are updated. All 3D points from a depth map are evaluated. If the other depth map sees this point, that depth map or image is added to the list of the overlapping images. In practice, through this process, the list of overlapping images is updated.

As depicted in FIG. 8B, a surface visibility check is done by comparing the distance of the 3D point P to the viewing position of depth map (e.g., the distance of P and p₄) and the depth value d₄ of back projected point p₄ from its depth map image (i₄). If the distance P to p₄ is larger than depth value d₄, then this point (P) is behind another surface and is not visible in i₄.

The above computation for all 3D points of all depth maps is time consuming. According to one or more embodiments, the following method is used for faster but approximate dendogram computation. In one case, existing matched features are used, if they are available, for example, from a photogrammetry feature matching process. In another case, a sample of 3D points is used. When using the sample of 3D points, instead of performing the computation for all 3D points of a depth map image, the 3D points are sub-sampled to a smaller grid. For example, instead of using all 3D points of a depth map of (m×n) 3D points, every k points are used. Therefore, only

$$( \frac{m}{k} \times \frac{n}{k} )$$

3D points are examined. In one example, k is a number that represents a percentage of the total 3D points, for example, 90%, 85%, 80%, 50%, etc.

### Input Parameters Determination

Depth map refinement and fusion operations require some parameters. The following sections describe these parameters

### Surface Normal Vector

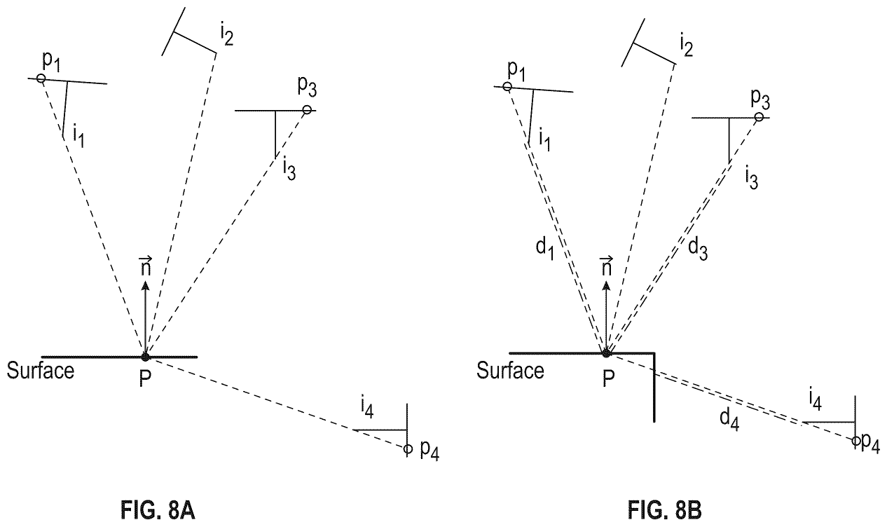

FIG. 9 shows the surface normal vector (\vec{n}) at a 3D point P₁. The surface normal vector (\vec{n}) is calculated by using neighboring points of P₁ in 3D space through a plane or a polynomial surface fitting. At least 3 non-linear points are needed to define a plane in 3D space. For higher order surfaces more 3D points are needed.

For better memory caching (e.g., increased speed), the computation of normal vectors are done in advance. In this process, the 3D points are first computed by using the depth value and the external orientation of the depth map image, for example, using any well-known process by one of ordinary skill in the art. Examples of the external orientation include 3 angles: ω, φ, k, which are the Euler angles representing the amount of rotation around the axes of the coordinate system and the 3 translation: X, Y, Z, which are the position of the projection center with the world coordinate system.

It should be noted that accuracy of normal vector estimation depends on noise, blunder, and sparsity of the 3D points around 3D point P₁. To reduce the effect of noise and blunders, usually points in a (5×5) window around the 3D point are used to contribute to the normal vector estimation. Methods like moving least squares are applied for speed-up, and better noise handling and more accurate estimation of the normal vector. Higher order surfaces like a quadratic surface are applied here as well.

### Ray And Surface Normal Vector

As depicted in FIG. 9, the ray and surface normal angle (θ) of a 3D point P₁ is computed through the following formula for two depth map images (i₁, i₂):

$$θ = a cos ( \frac{\vec{{n}_{1}} \cdot \vec{{v}_{2}}}{‖ \vec{{n}_{1}} ‖ ‖ \vec{{v}_{2}} ‖} ) . \qquad Equation 1$$

Equation 1 further includes the following.
θ: The angle between the ray (from p_{1,2}) and surface normal vector;
\vec{n₁}: Surface normal vector at P₁;
\vec{v₁}: Ray vector to the first image. It is constructed by two 3D points: point P₁, and the viewing position i₁; and
\vec{v₂}: Ray vector to the second image. It is constructed by two 3D points: point P₁, and the viewing position i₂; and
∥ ∥: A mathematical operator computing the norm of a vector.

### Scale Number Including Device Uncertainty

A scale number with device uncertainty is computed for a pixel in the depth map image by using the following formula:

$$s = α \cdot \frac{d}{c} . \qquad Equation 2$$

Equation 2 further includes the following.
s: Scale number, for example, if only one device used for depth measurement, the smaller value denotes the surface is closer to the viewing point;
c: The camera constant of the lens which is used in the measurement device (only in case of perspective projection), in other cases like static scanning it is 1;
d: Depth value from the depth map; and
α: Uncertainty factor of a device. For example, a is 1 if only once device is used for the depth measurement. If more than one device is used for depth map generation, the device with lower uncertainty has a smaller a value.

### 2.4 Depth Uncertainty

The uncertainty (or precision) of the depth depends on the method of data capture. Different devices have different uncertainties, and the following formula estimates depth uncertainty:

$$σ = ε ( d ) . \qquad Equation 3$$

Equation 3 further defines the following.
σ: Uncertainty of depth value;
d: Depth value; and
ε(d): Error function, which estimates the uncertainty of depth value.

In Equation 3, ε(d) is typically a linear function of d like, ε(d)=(a*d)+b, in which a is the percentage of depth value (d) and b is a constant value for all depth values.

### Signed Distance

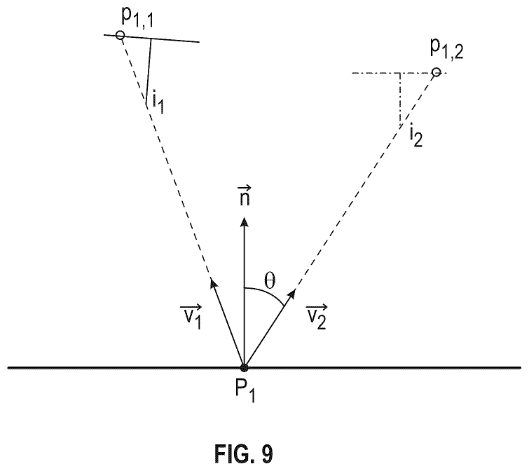

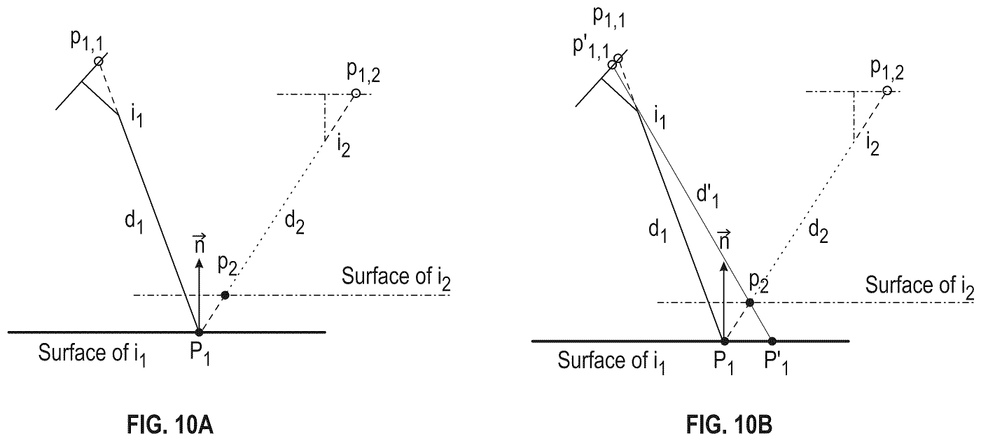

In FIG. 10A, the (first) signed distance is computed through the following steps: at step A, for a point p_{1,1} in image i₁, compute the 3D point P₁ by using the depth value d₁; at step B, back project 3D point P₁ into the next overlapping image i₂: p_{1,2}; at step C, by using the exterior orientation of i₂ and the depth value (d₂) of p_{1,2}, compute the 3D point: P₂; and at step D, the signed distance (δd_{1,2}) of p_{1,1} is computed using the following formula:

$$δ {d}_{1 , 2} = ‖ {P}_{2} - {P}_{1} ‖ . \qquad Equation 4$$

### Second Signed Distance

In addition to the above signed distance value in FIG. 10A, the second signed distance in FIG. 10B is computed through the following according to one or more embodiments; it is the continuation of the previous Signed Distance computation. At step 1, back project 3D point P₂ in the reference image i₁. This point is shown as p_{1,1}′ in FIG. 10B. At step 2, by using the depth value of p_{1,1}′, which is d₁′, compute the 3D point: P₁′. At step 3, the second signed distance of p_{1,1} is computed as follows:

$$δ {d}_{1 , 2}^{′} = ‖ {P}_{2} - {P}_{1}^{′} ‖ . \qquad Equation 5$$

In Equation 5, δd_{1,2}′ is the signed distance of p_{1,1}′.

In FIGS. 10A and 10 B, the surface generated by depth map image i₁, is shown by the solid line. 3D point P₁, which is computed by this depth map image, lies on this surface. The surface generated by the depth map image i₂ is shown by the dotted line. 3D point P₂, which is computed by the depth map of i₂ lies on this surface. Ideally P₁ and P₂ should be identical but due to system measurement of uncertainties there is a discrepancy between these two surfaces and these two points are separated.

### Depth Map Refinement

Each depth map is refined by using the overlapping depth maps. Refinement includes noise reduction, blunder detection, and partial surface registration using weighted averaging of overlapping depth maps.

For depth map image i₁, the following computes the correction vector \hat{Δ} to the position of the 3D point P₁ by using the following formula for all overlapped depth map images:

$$\hat{Δ} = \vec{\frac{Δ}{Ω}} . \qquad Equation 6$$

Equation 6 also includes the following.

| | |
|---|---|
| $\vec{Δ} = {\sum }_{i}^{overlaps} {Ω}_{1 , i} . {\vec{Δ}}_{1 , i}$ | is the sum weighted correction |
| $Ω = {\sum }_{i}^{overlaps} {Ω}_{1 , i}$ | is the sum of the weight values |

If ∥\hat{Δ}∥<κ and Ω<γ, the corrected position \hat{P}₁ is computed using the following formula:

$${\hat{P}}_{1} = {P}_{1} + \hat{Δ} . \qquad Equation 7$$

κ is a threshold which controls the amount of deviation or the size of the correction. κ is usually a percentage (for example, 50%) of depth uncertainty (e.g., Section 2.4). The larger the value κ, the reconstructed surface becomes noisier and more un-even. The smaller value (κ) creates a cleaner surface because it rejects more points; therefore, it creates holes in the fused point cloud.

γ is a threshold which controls the contribution of weights of different depth maps. The larger the value of γ implies more depth redundancy and higher confidence of fusion. It is usually around 2.

Using the following parameters below, depth refinement for determining the correction to a pixel in a depth map image is described by the following algorithm/process.

At step 1, the software applications 604 are configured to compute the 3D coordinates (the 3D point P₁) of the pixel (p_{1,1}) by using the exterior orientation values of the depth map and the depth value. Back project the 3D point P₁ in the next overlapping depth map image (i₂).

At step 2, the software applications 604 are configured to compute ray intersection angle (θ) of \vec{n₁} and \vec{v₂} by using Equation 1.

At step 3, the software applications 604 are configured to check if θ<90°, and then go to the next step if the condition is met; otherwise do nothing.

At step 4, the software applications 604 are configured to compute δd_{1,2} by using Equation 4.

At step 5, the software applications 604 are configured to compute σ by using Equation 3.

At step 6, the software applications 604 are configured to check if |δd_{1,2}|<σ.

At step 7, the software applications 604 are configured to go to the next step when the condition is met in step 6; otherwise do nothing.

At step 8, the software applications 604 are configured to compute scale numbers (s_{1,1} and s_{1,2}) by using Equation 2.

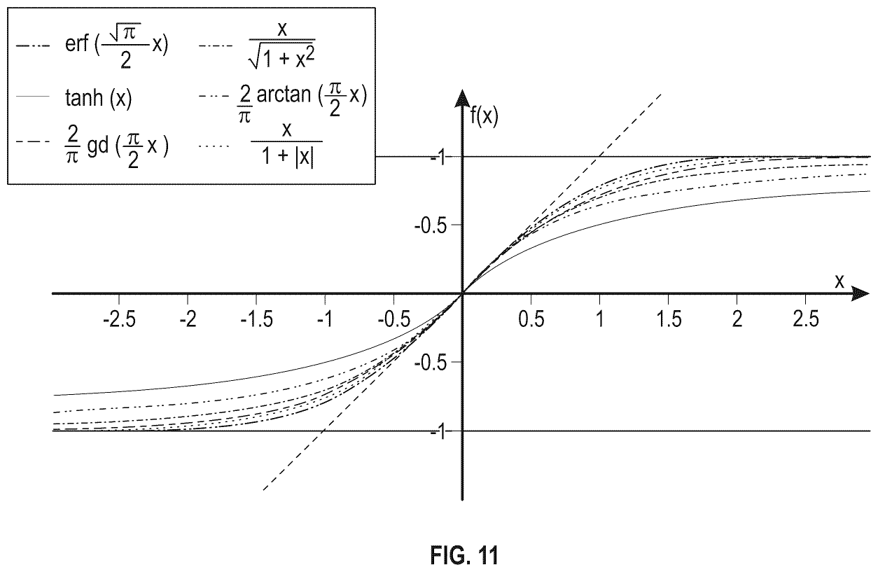

At step 9, the software applications 604 are configured to define the following weights:

$${w}_{1} = 1 - ω ( \vert δ {d}_{1 , 2} \vert ) , {w}_{2} = 1 , {w}_{4} = 1 - ω ( {( \frac{{s}_{1}}{{s}_{2}} )}^{2} ) , and {w}_{3} = cos ( θ )$$

in which, ω(x) is a weight function with the range of [0, 1]. Some of the well-known weight functions are shown in FIG. 11. The range of these functions is [−1, 1] but as the domain in our modeling is [0, ∞), then the range of these function will become [0, 1].

At step 10, the software applications 604 are configured to compute the average of the above weights using the following formula:

$${Ω}_{1 , 2} = {( {w}_{1} \cdot {w}_{2} \cdot {w}_{3} \cdot {w}_{4} )}^{\frac{1}{4}} ,$$

in which Ω_{1,2} is the weight related to point p_{1,2} computed from depth map of i₂.

At step 11, the software applications 604 are configured to compute the correction vector of depth map i₂ to the position of the 3D point P₁ as follows: \vec{Δ}_{1,2}=−δd_{1,2}. \vec{n₁}, in which \vec{n₁} is the normal vector at P₁.

This refinement is performed for each pixel. Once all pixels of the current depth map are corrected (i.e., also referred to as refined or adjusted) by using Equation 7, these new 3D points are used to compute the new depth map image. All depth maps are refined throughout this procedure. By iterating this process (e.g., 3 iterations) for all depth maps, a consistent correction is computed. Now, it is time to merge these new depth maps and create a fused point cloud. It should be appreciated that refinement or correction is done in 3D space. Through refinement, new 3D point coordinates are computed. At least one of these new point coordinates is then converted to a depth value. Using the depth value, the new depth value is the distance of the new 3D point and the depth map projection center/viewing point.

### Depth Maps Fusion

At this step, all overlapping depth map images, which contain redundant data, are fused to create a discrete surface without redundant 3D points. Most computation steps at this phase are like depth refinement described in Section 3. The difference between depth map fusion and depth map refinement is that depth map fusion is not iterative and is performed only once per each pixel and per image.

At step 1, the software applications 604 are configured to compute the 3D coordinates (P₁) of the pixel (p_{1,1}) by using the exterior orientation values of the depth map and the depth value. Back project P₁ in the next overlapping depth map image (i₂).

At step 2, the software applications 604 are configured compute ray intersection angle (θ) of \vec{n₁} and \vec{v₂} by using Equation 1.

At step 3, the software applications 604 are configured to check if θ<90°, and then go to the next step if the condition is met; otherwise do nothing.

At step 4, the software applications 604 are configured to compute δd_{1,2} by using Equation 4.

At step 5, the software applications 604 are configured to compute σ by using Equation 3.

At step 6B (unlike step 6 above), the software applications 604 are configured to check if δd_{1,2}<−σ, and when this condition is met, go to the next step; otherwise do nothing.

At step 7B (unlike step 7 above), the software applications 604 are configured to check if s_{1,2}<s_{1,1}, and when s_{1,2}<s_{1,1}, skip this point for the fusion, because p_{1,2} is better to be the reference for the fusion.

At step 8, the software applications 604 are configured to compute scale numbers (s_{1,1} and s_{1,2}) by using Equation 2.

At step 9, the software applications 604 are configured to define the following weights:

$${w}_{1} = 1 - ω ( \vert δ {d}_{1 , 2} \vert ) , {w}_{2} = 1 , {w}_{4} = 1 - ω ( {( \frac{{s}_{1}}{{s}_{2}} )}^{2} ) ,$$

and w₃=cos(θ) in which, ω(x) is a weight function with the range of [0, 1]. Some of the well-known weight functions are shown in FIG. 11. The range of these functions is [−1, 1] but as the domain in our modeling is [0, ∞), then the range of these function will become [0, 1].

At step 10, the software applications 604 are configured to compute the average of the above weights using the following formula:

$${Ω}_{1 , 2} = {( {w}_{1} \cdot {w}_{2} \cdot {w}_{3} \cdot {w}_{4} )}^{\frac{1}{4}} ,$$

in which Ω_{1,2} is the weight related to point p_{1,2} computed from depth map of i₂.

At step 11, the software applications 604 are configured to compute the correction vector of depth map i₂ to the position of the 3D point P₁ as follows: \vec{Δ}_{1,2}=−δd_{1,2}·\vec{n₁}.

The final point coordinate (the final/fused 3D point cloud) is computed using Equation 7. According to an embodiment, each 3D point (e.g., 3D point P₁) of a depth map is moved to its corrected position \hat{P}₁ by moving the current position (of the 3D point P₁) by the amount of the correction vector \hat{Δ}. The other difference between depth map fusion with respect to depth refinement is that the new depth values are not computed anymore.

### Increased Computation Speed and Improved Memory Management

Computation of normal vectors is time consuming and require memory to store them. In addition, if the depth map is noisy, the normal vectors are approximate values and do not necessarily represent the true surface normal vector. According to one or more embodiments, a method is proposed in this section to bypass the computation and storage of the normal vector.

Instead of using the normal vector (\vec{n₁}), the viewing vector (\vec{v₁}) of the reference depth map (e.g., in FIG. 9) is used as an approximated value of the normal vector in all above steps. To resolve the viewing direction ambiguity, the second signed distance value is considered in the computation of w₂ in Section 3 and step 9 as the following:

$${w}_{2} = 1 - ω ( {( max ( \vert \frac{δ {d}_{1 , 2}}{δ {d}_{1 , 2}^{′}} \vert , 1 ) - 1 )}^{2} ) . \qquad Equation 8$$

Computation of the second signed distance is straight forward and computationally less expensive (i.e., requires fewer computer processing resources of the processors) compared to the normal vector computation. On-the-fly computation is performed in one or more embodiments therefore no need of storing them in advance. By this way, the computation is faster without using the normal vector computation and less memory resources are utilized.

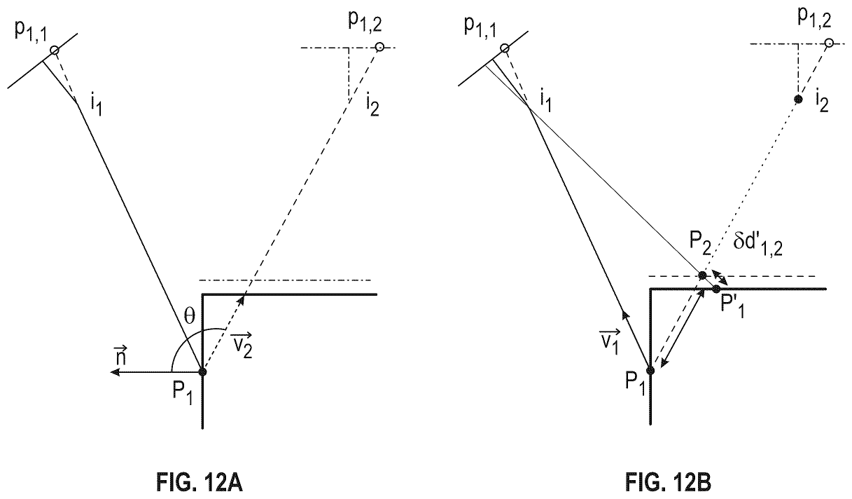

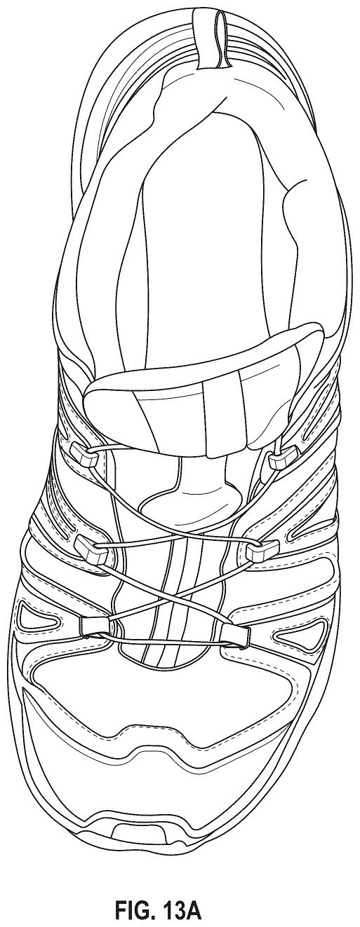

FIGS. 12A and 12B illustrate replacing the normal vector (\vec{n₁}) with the viewing vector (\vec{v₁}). In FIG. 12A, P₁ is not visible in image i₂ because the ray and normal vector intersection angle (θ) is larger than 90°. If the normal vector is replaced with viewing vector (\vec{v₁}), the visibility check is not done correctly. In FIG. 12B, in order to resolve this situation, the ratio of the signed distance to the second signed distance

$$( \vert \frac{δ {d}_{1 , 2}}{δ {d}_{1 , 2}^{′}} \vert )$$

is computed. If this ratio is larger than a predefined threshold, consider that P₁ is not visible in i₂. This condition is folded in the Equation 8. For example, w₂ will become very small for the situation FIG. 12B which means that P₁ is not visible in image i₂ because of w₂ is too small and does not meet the threshold.

### 6. Results

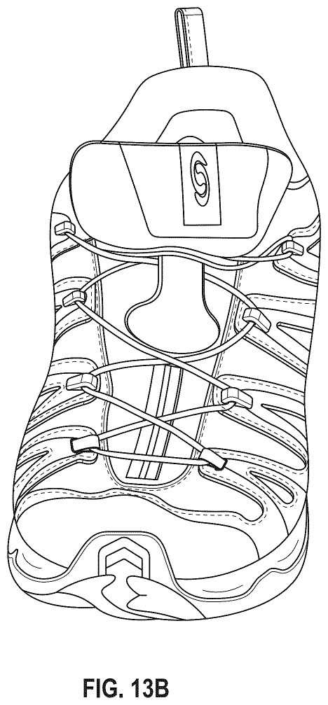

FIGS. 13A and 13B depict a fused point cloud with photogrammetry using different handheld cameras according to one or more embodiments. FIGS. 13A and 13B are different views of the fused point cloud for an object (e.g., a shoe). FIG. 13C is a zoomed in snapshot of the object surface of the fused point cloud, and it is evident that the location marked with the rectangle has a higher density or resolution. The area opposite the rectangle appears degraded or pixelated while the image inside the rectangle maintains its sharpness and clarity at the zoomed in view in FIG. 13C. Even at a further magnified view in FIG. 13D, it is evident that the 3D points of the rectangle have a greater density (i.e., a higher resolution), which is because the techniques of the embodiments described herein maintain the density of each original 3D point cloud (e.g., each device used) used in the final fused point cloud. Moreover, the technique chose the points from the overlapping regions (of the depth maps) in which those points were captured with a greater density or greater resolution.

A computer-implemented method of merging depth map images into a 3D point cloud is provided according to one or more embodiments. The method is implemented using a computer system, such as computer system 602 with software applications 604, according to an embodiment. The method includes determining correction 3D vectors (e.g., correction vector \hat{Δ}) to 3D positions (an example 3D point is represented as 3D point P₁ having an XYZ position) of first pixels of a first depth map, wherein a dendogram represents depth maps with overlap in a 3D space, the depth maps including at least the first depth map (e.g., depth map image (i₁)) and a second depth map (e.g., depth map image (i₂)) having second pixels. The method includes computing adjusted 3D positions of the first pixels (e.g., adjusted 3D point P′₁ corresponds to pixel p_{1,1} depicted in FIG. 10B) of the first depth map by using the correction 3D vectors. The method includes refining the first depth map by computing an adjustment to the first depth map by using the adjusted 3D positions of first pixels of the first depth map, wherein the second depth map includes other 3D positions (e.g., a 3D position (XYZ) is related to 3D point P₂) for the second pixels. Also, the method includes merging the first depth map and the second depth map, by selecting respective pixels from at least one of the first pixels of the first depth map or the second pixels of the second depth map, wherein the first pixels and the second pixels correspond to 3D points (e.g., 3D point P₁ or 3D point P₂ is selected) in the 3D space.

In one or more embodiments, wherein the first pixels and the second pixels are associated with devices used to capture the object, wherein the selecting of the respective pixels from the first pixels and the second pixels is based, at least in part, on which of the first and second pixels correspond to one of the devices that was positioned closer to a surface of an object being captured. In one or more embodiments, wherein the selecting is based, at least in part, on which of the devices has better resolution. In one or more embodiments, wherein the selecting is based, at least in part, on which of the devices has better uncertainty (e.g., uncertainty factor α). In one or more embodiments, wherein the selecting is based, at least in part, on which of the devices has a smaller scale number

$$( e . g . , scale number s = α \cdot \frac{d}{c} ) .$$

In one or more embodiments, wherein the selecting is based, at least in part, on which of the depth maps has a direct viewing angle to the surface.

Also, in one or more embodiments, wherein an original depth map resolution of the first pixels and second pixels is maintained while merging the first depth map and the second depth map.

According to an embodiment, a computer-implemented method for fusion of depth data from multiple sources is provided. The method includes determining correction 3D vectors to 3D positions of first pixels of a first depth map, wherein a dendogram represents depth maps with overlap in a 3D space, the depth maps including at least the first depth map and a second depth map having second pixels. The method includes computing adjusted 3D positions of the first pixels of the first depth map by using the correction 3D vectors. The method includes refining the first depth map by computing an adjustment to the first depth map by using the adjusted 3D positions of first pixels of the first depth map, wherein the second depth map comprises other 3D positions for the second pixels. Also, the method includes merging the first depth map and the second depth map, by selecting respective pixels from at least one of the first pixels of the first depth map or the second pixels of the second depth map, wherein the first pixels and the second pixels correspond to 3D points in the 3D space.

In addition to one or more features described herein, or as an alternative, further embodiments of the method may include wherein the first pixels and the second pixels are associated with devices used to capture the object, wherein the selecting of the respective pixels from the first pixels and the second pixels is based, at least in part, on which of the first and second pixels correspond to one of the devices that was positioned closer to a surface of an object being captured.

In addition to one or more features described herein, or as an alternative, further embodiments of the method may include wherein the selecting is based, at least in part, on which of the devices has better resolution.

In addition to one or more features described herein, or as an alternative, further embodiments of the method may include wherein the selecting is based, at least in part, on which of the devices has better uncertainty.

In addition to one or more features described herein, or as an alternative, further embodiments of the method may include wherein the selecting is based, at least in part, on which of the devices has a smaller scale number.

In addition to one or more features described herein, or as an alternative, further embodiments of the method may include wherein the selecting is based, at least in part, on which of the depth maps has a direct viewing angle to the surface.

In addition to one or more features described herein, or as an alternative, further embodiments of the method may include wherein an original depth map resolution of the first pixels and second pixels is maintained while merging the first depth map and the second depth map.

In addition to one or more features described herein, or as an alternative, further embodiments of the method may include wherein no nearest neighbor search is performed in a 2D space and the 3D space.

Other embodiments described herein implement features of the above-described method in computer systems and computer program products.

While one or more embodiments have been described in detail in connection with only a limited number of embodiments, it should be readily understood that the subject matter described herein is not limited to such disclosed embodiments. Rather, embodiments described herein can be modified to incorporate any number of variations, alterations, substitutions, or equivalent arrangements not heretofore described but which are commensurate with the scope of described one or more embodiments. Additionally, while various embodiments have been described, it is to be understood that aspects of the one or more embodiments include only some of the described embodiments. Accordingly, one or more embodiments are not to be seen as limited by the foregoing description but are only limited by the scope of the appended claims.

What is claimed is:

1. A computer-implemented method comprising:
capturing a plurality of images of an object in a three dimensional (3D) space with at least two imaging devices, the plurality of images including a first image of the object generated by a first imaging device and a second image of the object generated by a second imaging device having a different resolution than the first imaging device;
converting the first image into a first depth map having first pixels;
converting the second image into a second depth map having second pixels, at least one of the second pixels overlapping at least one of the first pixels;
identifying from the first depth map a first pixel that overlaps a second pixel from the second depth map;
selecting the second pixel as representing a correct position of the first pixel and the second pixel in the 3D space;
determining a correction vector for a position of the first pixel based on a distance from the second pixel;
determining adjusted positions of the first pixels using the correction vector;
determining an adjusted first depth map with the adjusted positions of first pixels, the second depth map comprising additional 3D positions for additional second pixels;
merging the second depth map with the adjusted first depth map; and
displaying a point cloud representative of the object based on the merging.

2. The computer-implemented method of claim 1, the selecting of the second pixel based at least in part on the second imaging device being closer to the object than the first imaging device.

3. The computer-implemented method of claim 1, the selecting based at least in part on the second imaging device having a better resolution than the first imaging device.

4. The computer-implemented method of claim 1, the selecting based at least in part on a lower uncertainty associated with the second imaging device than the first imaging device.

5. The computer-implemented method of claim 1, the selecting based at least in part on the second imaging device having a smaller scale number than the first imaging device.

6. The computer-implemented method of claim 1, the selecting based at least in part on the second depth map having a more direct viewing angle of the object than the first imaging device.

7. The computer-implemented method of claim 1, wherein an original depth map resolution of the first pixels and second pixels is maintained while merging the adjusted first depth map and the second depth map.

8. The computer-implemented method of claim 1, further comprising:
performing dendogram calculations to generate a data set representing each of the plurality of images; and
selecting the first image and the second image based on the dendogram.

9. A computer-implemented method comprising:
capturing a plurality of images of an object in a three dimensional (3D) space with at least two imaging devices, the plurality of images including a first image of the object generated by a first imaging device and a second image of the object generated by a second imaging device having a different resolution than the first imaging device;
converting the first image into a first depth map having first pixels;
converting the second image into a second depth map having second pixels, wherein at least one of the second pixels overlaps at least one of the first pixels;
identifying from the first depth map a first pixel that overlaps a second pixel from the second depth map;
selecting the first pixel as representing a correct position of the first pixel and the second pixel in the 3D space;
determining a correction vector for a position of the second pixel based on a distance from the first pixel;
determining adjusted positions of the second pixels using the correction vector;
determining an adjusted second depth map with the adjusted positions of second pixels, the first depth map comprising additional 3D positions for additional second pixels;
merging the first depth map with the adjusted second depth map; and
displaying a point cloud representative of the object based on the merging.

10. The computer-implemented method of claim 9, the selecting of the first pixel based at least in part on the second imaging device being farther from the object than the first imaging device.

11. The computer-implemented method of claim 9, the selecting based at least in part on the second imaging device having a lower resolution than the first imaging device.

12. The computer-implemented method of claim 9, the selecting based at least in part on a higher uncertainty associated with the second imaging device than the first imaging device.

13. The computer-implemented method of claim 9, the selecting based at least in part on the second imaging device having a larger scale number than the first imaging device.

14. The computer-implemented method of claim 9, the selecting based at least in part on the second depth map having a less direct viewing angle of the object than the first imaging device.

15. The computer-implemented method of claim 9, wherein an original depth map resolution of the first pixels and second pixels is maintained while merging the first depth map and the adjusted second depth map.

16. The computer-implemented method of claim 9, further comprising:
performing dendogram calculations to generate a data set representing each of the plurality of images; and
selecting the first image and the second image based on the dendogram.

17. A system comprising:
a memory having computer readable instructions; and
at least one processor for executing the computer readable instructions to perform operations comprising:
capturing a plurality of images of an object with at least two imaging devices, the plurality of images including a first image of the object generated by a first imaging device and a second image of the object generated by a second imaging device having a different resolution than the first imaging device;
performing dendogram calculations to generate a data set representing each of the plurality of images; and
selecting the first image and the second image based on the dendogram. converting the first image into a first depth map having first pixels;
converting the second image into a second depth map having second pixels, wherein the second pixels overlap the first pixels in three dimensional (3D) space;
selecting one of the first pixels and the second pixels as representing true positions of corresponding points in the 3D space;
determining correction vectors for unselected pixels in the 3D space based on distances from the selected pixels;
determining adjusted positions of the unselected pixels in the 3D space using the correction vectors;
determining an adjusted depth map with the adjusted positions of unselected pixels;
merging a depth map of the selected pixels with the adjusted depth map of the unselected pixels; and
displaying a point cloud representative of the object based on the merging.

18. The system of claim 17, wherein each of the converting, selecting, determining and merging operations are performed iteratively in sequence at least three times to improve an accuracy of the point cloud.

19. The system of claim 17, the first depth map and the second depth map comprising 2D arrays of distances, whereby a nearest neighbor search of the first pixels and the second pixels in the 3D space is not performed.

20. The system of claim 17, wherein the adjusted positions are computed using weighted averages that reduces noise such that the first pixels and second pixels that overlap complement each other.
